(19) United States
(12) Patent Application Publication
(10) Pub. No.: US 2008/0077960 A1
(43) Pub. Date: Mar. 27, 2008

(54) ADAPTABLE PROGRAMMING GUIDE FOR NETWORKED DEVICES

(75) Inventor: Theodore L. Griggs, Woodside, CA (US)

Correspondence Address: MORRISON & FOERSTER, LLP, 555 WEST FIFTH STREET, SUITE 3500, LOS ANGELES, CA, 90013-1024, US

(73) Assignee: Digital Deck, Inc., Redwood City, CA (US)

(21) Appl. No.: 11/949,710

(22) Filed: Dec. 3, 2007

Related U.S. Application Data
(63) Continuation of application No. 10/000,495, filed on Oct. 30, 2001.
(63) Continuation-in-part of application No. 09/909,676, filed on Jul. 19, 2001, now abandoned.
(60) Provisional application No. 60/244,790, filed on Oct. 31, 2000.
(60) Provisional application No. 60/219,857, filed on Jul. 20, 2000.
(60) Provisional application No. 60/233,581, filed on Sep. 19, 2000.

(51) Int. Cl. G06F 3/00

(52) U.S. Cl. 725/46

(57) ABSTRACT

A system and method for scheduling and distributing program is disclosed. The schedule utilized in the system and method preferably comprises a source field and one or more corresponding content data fields. The source field lists program providers and the content fields lists programs that are available from the program providers. The schedule is preferably configured to list programs having different start times and/or different ranges of duration times within entries of the same column. In the preferred method of the instant invention, the schedule is generated from user preferences that include selected program providers. In the system of the instant invention, the schedule is a displayable electronic schedule, wherein a user can select programs listed within the schedule with a suitable control device in order to initiate the distribution of the selected program to a user location over a network.

### CROSS-REFERENCE TO RELATED APPLICATIONS

The present application is a continuation of co-pending U.S. patent application Ser. No. 10/000,495 filed Oct. 30, 2001, which in turn claims priority from U.S. Provisional Patent Application No. 60/244,790, filed Oct. 31, 2000 and is a continuation-in-part of U.S. patent application Ser. No. 09/909,676, filed Jul. 19, 2001, which claim priority from U.S. Provisional Patent Application No. 60/219,857 filed Jul. 20, 2000 and U.S. Provisional Patent Application No. 60/233,581, filed Sep. 19, 2000, all of which are hereby incorporated by reference.

### FIELD OF THE INVENTION

The present invention relates to systems for and methods of distributing content data. More specifically, this invention relates to systems for and methods of distributing programs from customized program schedules.

### BACKGROUND OF THE INVENTION

There are numerous media services which provide scheduled programs on a viewing device, such as a television set. There are standard broadcast services which provide channels that can be received by virtually any television tuner through an antenna connector. There are cable services which typically offer packages of preselected channels to the consumers and that required a decoder at the television tuner or on the cable line at an external location. Cable services continuously broadcast scheduled programming through a preselected set of channels which are received through a cable connector on a television set. There are also a number of pay-per-view services which allow customers to receive scheduled one time program transmissions through the cable network. Other available services include satellite programming which allow consumers to select on demand pay-per view-programs from a set of available programs.

Each of these programming services require that consumers monitor program availabilities to determine if a desired program is offered. None of the current program services provide a single convenient system for users to select programs offered from different program providers.

### SUMMARY OF THE INVENTION

The current invention provides a system for and method of conveniently viewing and selecting programs offered from a number of program providers. Preferably, the system and method of the instant invention allow a user to view a customized program schedule tailored to the user's program interests and/or needs. Further, it is preferred that the user can control the program schedule in a number of different ways to modify the schedule to reflect the user's changing interests and/or needs.

Accordingly, the schedule utilized in the instant invention is configured for displaying content information for content data that is available from a plurality content providers. The schedule preferably list the names, and/or symbol, of the content providers as entries within a source field. The schedule preferably lists corresponding content availabilities as entries within a content field. Entries within the source field and corresponding entries within the content field are preferably arranged in parallel columns and aligned with each other, such that a person viewing the schedule can read the name, and/or the symbol, of content providers and corresponding content availabilities from left to right.

Content data availabilities that are listed within the content field preferably include times that content data is available from each of the providers. For example, the schedule can list start times and finish times for content data available from scheduled content data providers. In addition, the schedule can list duration times for content data available from on-demand content data providers. The schedule utilized in the instant invention is particularly useful for organizing and displaying content data available from both scheduled content providers and on-demand content providers within a single viewable or readable frame. Preferably, a portion of the content data listed describes on-demand digital video programs available from one or more of the content providers.

In accordance with an embodiment of the instant invention, the content field is configured to list a first set of entries corresponding to program times, as described above. The first set of entries can also list titles, names and/or descriptions of available programs. A second set of entries within the content field can list additional program availabilities and/or provide additional information regarding programs listed in the first set of entries. For example, the second set of entries can list costs and/or download times of video programs available from one or more content providers. Preferably, the second set of entries are arranged in a parallel column that is aligned with each corresponding entry from the first set of entries and corresponding source providers.

The schedule utilized in the instant invention is preferably an electronic program schedule that is displayable on an electronic device such as a computer screen or television screen. A user is preferably capable of selecting a program from the schedule, whereby the selected program is received and/or viewed at a specified user location. Preferably, a portion of the selected programs are transmitted to the user location over a suitable network, such as a cable network or the internet.

In further embodiments of the invention, the schedule is configured with a descriptor field. The descriptor field is configured for displaying a detailed description of one or more programs that are available from the content providers. Preferably, the descriptor field is configured to provide a description of a program that is selected by a user from the schedule and/or is available at the time that the schedule is being viewed.

In yet further embodiments of the instant invention, the schedule has a search field that allows a user to search program availabilities from content providers. Preferably, the search field allows the user to enter a subject, a term, a set of terms, a time and/or a range of times and initiate a search for programs that correlate with the subject, the term, the set of terms, the time and/or the range of times entered within the search field. The system of the instant invention preferably searches a data-base that includes program availabilities for content providers which are listed on the schedule and/or program availabilities for networked content providers not listed on the schedule.

In still further embodiments of the instant invention, the schedule comprises one or more appliance fields that preferably comprise entries listing a networked appliance. The appliance fields also preferably include status entries for listing the status the networked appliance. In accordance with this embodiment, the schedule also preferably comprises a control field for selectively controlling the networked appliance.

The schedule can also have a filter field with one or more filter selections. The filter selections are configured to regulate or filter providers and/or program availabilities to be listed as entries within schedule. For example, a filter selection can be programmed to prevent all Western programs from being listed in the schedule. By selecting this filter, programs containing Western content data will be excluded from the program schedule.

In a preferred method of the instant invention, the program schedule is generated from a list of user preferences. User preferences can includes but are not limited to selected content providers, user likes, user dislikes and/or user availabilities. The user preferences are then used to select programs that are compatible with the user preferences. Preferably, user preferences are stored on a remote server, wherein the user can accesses his or her account and modify the user preferences to generate an updated program schedule. In other embodiments of the instant invention, the program schedule is automatically updated. For example, the program schedule can be configured to automatically and periodically update based on programs selected from the schedule.

The system of the current invention preferably comprises a suitable controller device for selecting programs from a program schedule, as described above. Preferably, the program schedule is displayable on a monitor or television, wherein the user can view the schedule and select programs on-demand and/or information regarding programs by selecting a section of the screen listing one or more entries of interest. Suitable controller device include, but are not limited to, a mouse, a keyboard and an infrared remote control. The control device can include a touch sensitive screen, whereby the user can select programs on-demand and/or information regarding programs by touching a section of the screen listing one or more entries of interest. In operation, selected programs are preferably transmitted to an internet appliance at a user location, where the programs are viewed directly or downloaded to a memory device.

### BRIEF DESCRIPTION OF THE DRAWINGS

FIG. 1 shows a schedule format for listing program providers and corresponding program availabilities, in accordance with the instant invention.

FIG. 2 shows a schedule format with a search field for searching program availabilities, in accordance with the instant invention.

FIG. 3 shows a schedule format for listing program providers, program availabilities and networked appliances, in accordance with the instant invention.

FIG. 4 shows a schematic representation of a system for displaying a program schedule and for selecting programs from a displayable program schedule, in accordance with the instant invention.

FIGS. 5a-c show several network configurations for distributing content data, in accordance with the current invention.

FIG. 6 shows an architecture for distributing content through a network coupled to a plurality of content providers, in accordance with the instant invention.

FIG. 7 illustrates a personal computer interfacing a television for receiving and viewing content data over a network, in accordance with a preferred embodiment of the current invention.

FIG. 8 illustrates an architecture for distributing content data through a private network, in accordance with an alternative embodiment of the current invention.

FIG. 9 illustrates an architecture for controlling transmissions of content data from a first location to a second location, in accordance with the current invention.

FIG. 10 is a flowchart outlining the steps for distributing content data, in accordance with a method of the instant invention.

FIG. 11 is a flow-chart outlining the step for selecting a program in accordance with a preferred method of the instant invention.

### DETAILED DESCRIPTION OF A PREFERRED EMBODIMENT

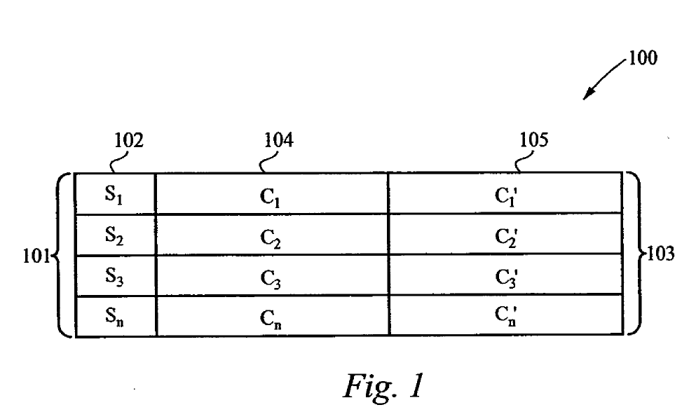

Referring to FIG. 1, the schedule 100 utilized in the instant invention is configured for displaying content information for content data available from a plurality content providers. The schedule 100 preferably list the names, and/or symbols, of the content providers as entries S₁, S₂, S₃ and Sₙ within a source field 101. The schedule 100 preferably lists corresponding content data availabilities as entries C₁, C₂ and C₃ within a content data field 103. Entries S₁, S₂, S₃ and Sₙ within the source field 101 and corresponding entries C₁, C₂, C₃ and Cₙ within the content data field 103 are preferably arranged in parallel columns 102 and 104 as shown, such that a person viewing the schedule 100 can read the name, and/or the symbol, of a content provider and its corresponding content data availability from left to right.

Still referring to FIG. 1, the schedule 100 can also lists a second set of entries C₁′, C₂′, C₃′ and Cₙ′ within a second column 105 of the content data field 103. The second set of entries C₁′, C₂′, C₃′ and Cₙ′ can list additional programs available from the content providers S₁, S₂, S₃ and Sₙ listed within the source field 101 and/or provide additional information regarding the programs availabilities C₁, C₂, C₃ and Cₙ listed in the column 104.

Content data availabilities listed as entries in C₁, C₂, C₃ and Cₙ and/or C₁′, C₂′, C₃′ and Cₙ′ preferably include times that programs are available from each of the providers S₁, S₂, S₃ and Sₙ. For example, the schedule 100 can list start times and finish times for programs available from scheduled program providers and list duration times for programs available from on-demand program providers. For entries in column 104 that list an on-demand program, the down-load time and/or cost of the on-demand program is preferably listed as an adjacent entry in the column 105.

Because, the program schedule 100 of the instant invention is configured to list program times and or duration times as individual entries from each program, the schedule 100 is particularly useful for organizing and displaying program availabilities from both schedule program providers and on-demand program providers in a single viewable schedule frame.

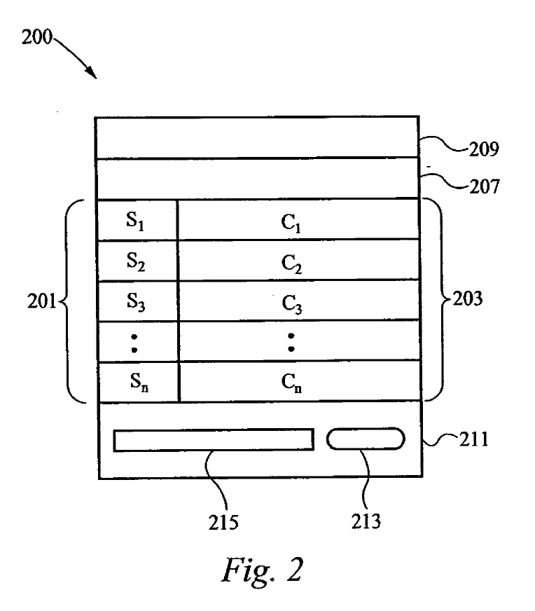

FIG. 2 shows a schedule format 200 that is configured to list and number of the content providers as entries S₁, S₂, S₃ to Sₙ within a source field 201 any to list any number of corresponding entries C₁, C₂, C₃ to Cₙ within a content data field 203. In accordance with this embodiment, the schedule 200 has a search field 211 that allows a user to search for program availabilities from program providers S₁, S₂, S₃ to Sₙ listed in the source field 201 and/or other networked program providers, as described below.

In operation a user enters a subject, a term, a set of terms, a time and/or a range of times within data window 215. A search is preferably initiated by selecting an enter button on a key board or clicking on a search icon 213 displayed in the search field 211 using a suitable control device, such as mouse.

In further embodiments of the instant invention the schedule 200 is configured with windows that 207 and 209 configured for listing advertising and/or streaming information such a weather reports, sports scores and or local events. Preferably, the program schedule 200 also displays the local time in one of the schedule windows 207 and 209, or another suitable location on the schedule 200.

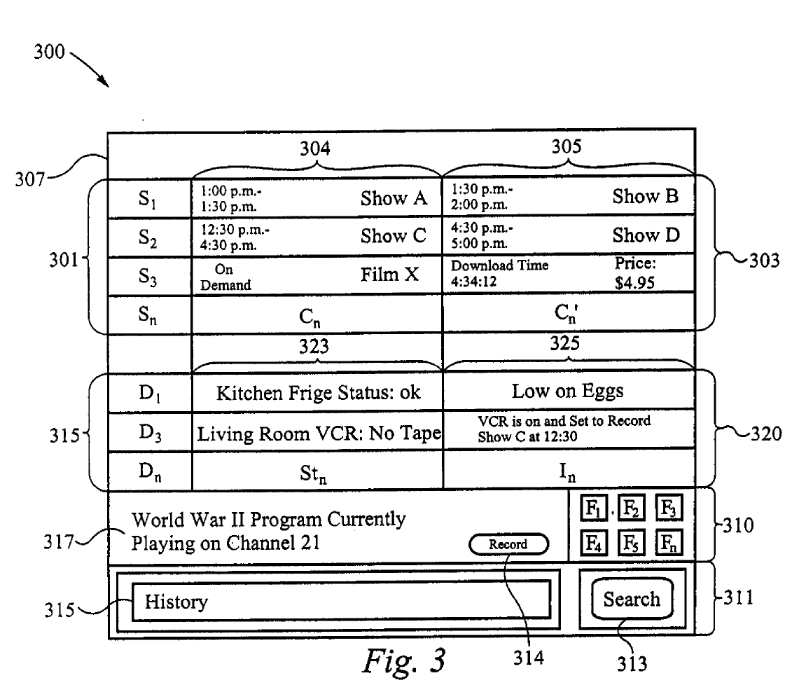

FIG. 3 shows program schedule 300 for listing program providers and program availabilities in accordance with further embodiments of the instant invention. The program schedule 300 lists any number of the content provider entries S₁, S₂, S₃ to Sₙ within a source field 301 and any number of corresponding content entries Cₙ and Cₙ′ within the content data field 303, as described previously in reference to FIG. 1. The schedule 300 preferably lists content data entries in columns 304 and 305 of the content data field 303. For example, within the column 304 an entry for a Show A is listed as being available from a scheduled program provider S₁. The Show A has a start time of 1:00 PM and a finish time of 1:30 PM. Within the column 305, a Show B is listed as being available from the schedule program provider S₁ after the Show A. The Show B has a start time of 1:30 PM and a finish time of 2:00 PM. Similarly, within the column 304a Show C is listed as being available from a schedule program provider S₂. The Show C has a start time of 12:30 PM and a finish time of 4:30 PM. Within the column 305, a Show D is listed as being available from the schedule program provider S₂ after Show C. The Show D has a start time of 4:30 PM and a finish time 5:00. It will be apparent that additional columns can be present.

Still referring to FIG. 3, the program schedule 300 also preferably lists one or more on-demand program providers within the source field 301 along with corresponding on-demand content data entries within the columns 304 and 305 of the content data field 303. For example, within the source field 301 a name or symbol for an on-demand content provider S₃ is listed. Within the column 304a, Film X is listed as being available from the on-demand program provider S₃. Within the column 305, additional information regarding Film X is provided, such as an estimated down-load time for down-loading a digital version the film to an internet appliance over the internet. In this example, the Film X is listed as having an estimated down-load time of 4 hours, 34 minutes and 12 seconds. Within the column 305, additional information such as the cost for receiving the program transmission can be listed. In this example, the cost for receiving the program transmission is listed as costing four dollars and ninety-five cents. In operation, the user can select a program from the schedule 300 and the user's account will automatically register the selection of the program, as explained in detail below.

In still further embodiments of the instant invention, the schedule 300 comprises one or more appliance fields 315 and 320. The appliance field 315 list types of networked appliances D₁, D₂ to Dₙ. The appliance field 320 preferably lists additional information about the appliances D₁, D₂ to Dₙ as data entries in the columns 323 and 325. Additional information can include, a location, a description and/or a status or one or more networked appliances, as described in the following examples.

In FIG. 3, the appliance D₁ is described in the column 323 as a Kitchen Refrigerator. Within the same data entry, the status of the Kitchen Refrigerator is listed as being “OK”. The appliance data entries can be configured to be continuously or periodically updated to reflect status changes in the appliance. For example, in the event that the Kitchen Refrigerator becomes unplugged, the status entry in the column 323 can be updated through a suitable network to list “please check”, “need service” or other suitable entry that alerts a viewer to the change in status.

Still referring to FIG. 3, within a second set of entries in the column 325, additional information regarding the networked appliances D₁, D₂ to Dₙ can be provided. For example, the entry corresponding to D₁ within the column 325 alerts a viewer that the Kitchen Refrigerator is low on eggs. The entry can be configured to provide the viewer with other information regarding the operation of Kitchen Refrigerator such as alerting the viewer when the door of the Kitchen Refrigerator is open or has been left open.

In accordance with a preferred embodiment of the invention, at least one of the networked appliances D₁, D₂ to Dₙ is an entertainment appliance for viewing or recording programs selected from the schedule 300. In the example illustrated, an entertainment appliance D₂ is listed as a living room VCR. Within the appliance entry of column 323, the VCR is listed as having no-tape, alerting a user that a cassette tape must be provided before recording a program. The schedule 300 preferably comprises at a selectable control field 314 that allows a user to operate the VCR, or other networked entertainment appliance to play, record and/or view programs. For example, the user can select the Show C using a suitable control device, as described below, and select the record icon listed within the control field to program the VCR to automatically record the Show C. A second entry within the column 325 lists a detailed status of the VCR. In this example, the second entry within the column 325 tells the viewer that the VCR is on and that the VCR is programmed to record the Show C at 12:30 PM.

In still a further embodiment of the invention, the schedule 300 is configured with a filter field 310 having one or more filter selections F₁, F₂, F₃, F₄, F₅ and Fₙ. The filter selections F₁, F₂, F₃, F₄, F₅ and Fₙ are preferably selectable to filter out or regulate either content providers and/or program availabilities listed in the program schedule 300. For example, a selectable filter selection can be programmed to prevent all Western programs from being listed within the content field 303. Alternatively, a selectable filter selection can be programmed to prevent all Sports program providers from being listed in the source field 310. The schedule format 300 can also include headers or footers for listing advertising, streaming weather reports, reporting sports scores, reporting local events and/or providing the local time.

In yet a further embodiment of the invention, the schedule 300 is configured with a descriptor field 317. The descriptor field is 317 is configured for listing a detailed description of one or more programs that are available from the content providers. For example, when a user enters a search for History programs within the search field 315, the descriptor field 317 can be configured to describe history programs currently available from providers listed on the schedule 300 and/or other networked providers, as described below.

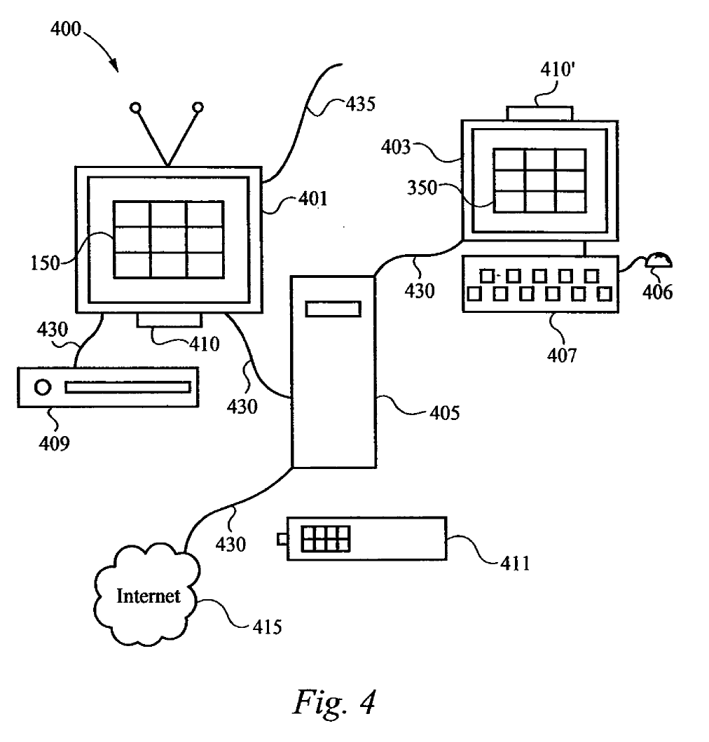

Now referring to FIG. 4, the schedule utilized in the instant invention is preferably an electronic program schedule 150 and 350 that is displayable on an electronic device, such as a television screen 401 or computer screen 403. The schedule 150/350 is supported through a computer 450 which hosts the hardware and software to support and display the program schedule 150/350 on the screens 410 and/or 403. A user is preferably capable of selecting a program from the program availabilities listed on the schedule 150/350 with a suitable control device including a mouse 406, a key board, 407 and/or an infrared remote control 411. The monitors can be equipped with infrared sensors 410 and/or 410′ that are responsive to commands from the infrared remote control 411.

Still referring to FIG. 4, a local area network 430 preferably couples the computer 405 with media playing appliances, such as a VCR player and/or a DVD player. The computer 405 is also preferably coupled to the internet 415 through a suitable connection, such that selected on-demand programs are capable of being transmitted to the computer 405 from a remote server via the internet. The television 401 can also be coupled to program providers through a cable network 435 to receive scheduled programs listed on the program schedule 150/350.

In a preferred method of the instant invention the electronic program schedule 150/350 is generated from a list of user preferences. User preferences can include, but are not limited to selected content providers, user likes, user dislikes and/or user availabilities. A distribution network provides a link between a user location and the a remote server which stores the user preferences and the electronic program schedule in a user account. The user can access his/her account through the network to view the schedule and/or modify the account to generate an updated program schedule. In another embodiment of the instant invention, the program schedule is automatically updated. For example, the system and network can be configured to automatically updated the program schedule based on the user's habits, such automatically added programs selected from previous version of the user's schedule.

The distribution architecture of the instant invention preferably utilizes a server unit coupled to remote content providers. The server unit provides a central hub for content data distribution. The server unit monitors content data availabilities from the content providers and organizes the program availabilities into customized program schedules in accordance with user codes.

The user codes preferably provide for a selection of services desired from the content provider. The user codes can also provide for the selection of content data based on information about the intended user, wherein the content data corresponds to scheduled or on demand programs, which may viewed or played at user locations.

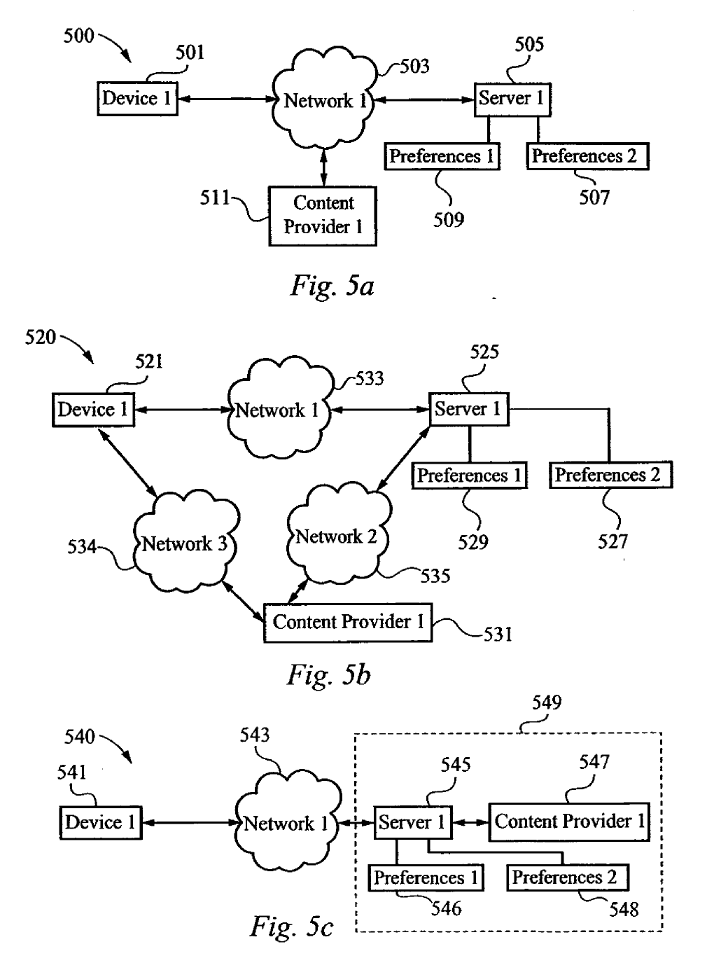

A user preferably can view or access their account and select programs to be transmitted to a predetermined location and/or modify account preferences including, changing content providers and/or services provided therefrom. FIGS. 5a-c will now be used to show several different ways in which a system server may be coupled to content providers for distributing content data to user location, in accordance with the instant invention.

FIG. 5a shows an architecture 500 for distributing content data, in accordance with an embodiment of the invention. The architecture 500 preferably has a central network 503. The central network 503 can be either a private or public access network, such as the internet. A system server 505 is coupled to at least one content provider 511 though the network 503. In the architecture 500 shown in FIG. 5a, a user can access their account at the server 505 via the network 503 from a device 501, which is also configured to receive program transmissions. Alternatively, the user can access their account at the server 505 from a separate device (not shown). Preferably the user can change preferences 507 and 509 and or select a programs their personal account. Preferably, the system server 505 instructs the content provider 511 via the network 503 to route a program transmission to the device 501.

In accordance with one embodiment of the current invention, the system server 505 authorizes and initiates program transmissions to the device 501 by providing the content provider 511 with a logical address of the device 501 or location of the device 501 on the network. Alternatively, the server causes the device 501 to authorize and initiate program transmissions from the provider 511 to the device 501.

According to an alternative embodiment of the instant invention, program transmissions are automatically initiated from the content provider 511 to the device 501 based on the preferences 507 and 509 and/or a program schedule without requiring the user to make a program selection.

FIG. 5b show an alternative architecture 520 for distributing content data, in a accordance with the current invention. The architecture 520 has a server 525 that stores the preferences 527 and 529 which are used to create program schedules, as previously described. The architecture 520 has a first network 533, which is preferably a public network, such as the internet, wherein a user can access their account through the public network 533. The system server 525 and a content provider 531 are coupled through a separate network 535 which may be a local area network or other restricted access network. The network 535 is preferably configured to provide the server 525 with content data availabilities from the content data provider 531. The network 534 provide a mechanism for the distribution of program data from the content provider 531 to a receiving device 521. Preferably, the network 533 is a private pay-for-view user network.

FIG. 5c show an architecture 540 for distributing content data, in accordance with another alternative embodiment of the current invention. The architecture 540 preferably comprises a server unit 549 coupled to a receiving device 541 through a network 543. The server unit 549 comprises a content source 547 and a system sever 545, wherein the content source 547 provides programs to the device 541 through the system server 545. The system server 545 allocates content data availabilities into program schedules in accordance with the stored preferences 546 and 548 and transmits programs automatically, by way of user selections from schedules or a combination thereof.

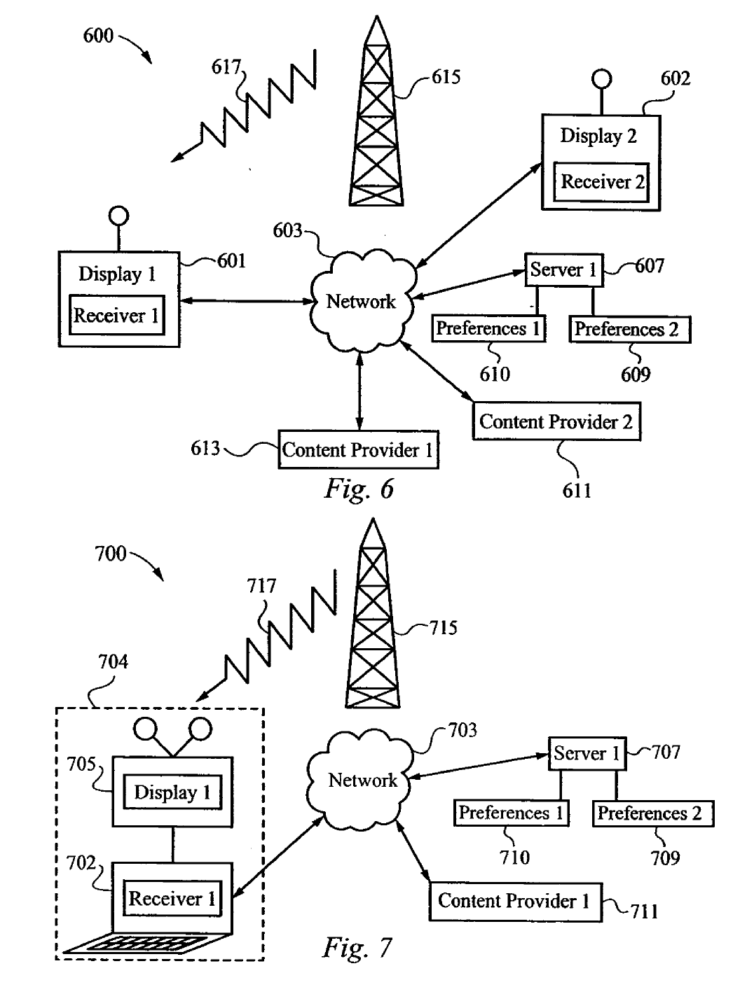

FIG. 6 shows an architecture 600 for distributing content data to multiple devices 601 and 602 from multiple content providers 611, 613 and 615. The content providers 611 and 613 transmit content data to the devices 601 and 602 through a network 603. The network 603 is preferably a private pay-for-use network or, alternatively, is a public network, such as the internet. The devices 601 and 602 preferably each have a receiver for receiving content data and a display for displaying processed or unprocessed content data received at a user location.

Still referring to FIG. 6, a broadcast content provider 615 broadcasts content data 617, such as television program transmissions or any other kind of broadcast content data. The broadest content provider 615 can selectively operate independently of the system server 607 or, alternatively, can be coupled to operate cooperatively with the server 607, wherein the server 607 provides instructions to the broadest content provider 615 to initiate selective broadcasts to one or more of the devices 601 and 602. Accordingly, the server 607 is configured to program the receiver device 601 to receive broadcast data 617 from the broadest content provider 615 according to a schedule. The server 607 preferably stores customized program schedules generated in accordance with user preferences 610 and 609.

FIG. 7 shows an architecture 700 for distributing content data, in accordance with a preferred embodiment of the current invention, wherein a receiver device 704 comprises a personal computer 702 and a television set 705. The personal computer 702 can be coupled to a network 703 and configured to access a server 707 where program schedules are stored in personal accounts. A content provider 711 is preferably is coupled to the network 703 and configured to transmit program data via the network 703 to the device 704 in accordance with the program schedules. As described previously, program schedules are preferably generated in accordance with user preferences 709 and 710 which are also stored on the server 707.

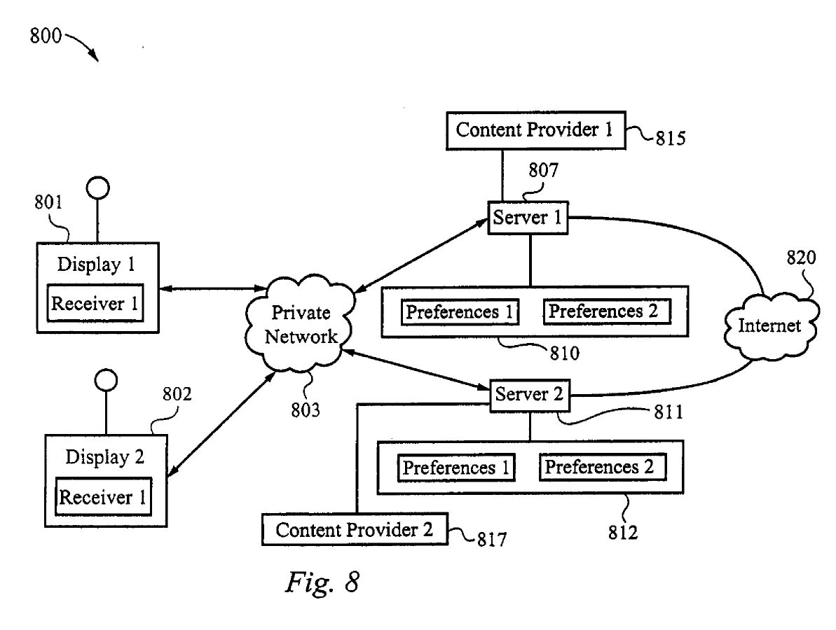

FIG. 8 shows an architecture 800 for distributing content data, in accordance with an alternative embodiment of the current invention. The architecture 800 can include multiple servers 807 and 811. The architecture 800 preferably includes a network 803 that is preferably a private network for users subscribing to an account at one or more of the servers 807 and 811. Each server 807 and 811 is preferably coupled to content data provider 815 and 817, respectively. The servers 807 and 811 monitor availabilities of content data from their respective content data providers 815 and 817 and compile customized schedule catalogs for each set of user preferences 810 and 812. The internet appliances 801 and 802 preferably each have a receiver for receiving programs and one or more display for displaying process program data. A user can access their user account and view their program schedule therein via the internet 820 from one or more of the internet appliances 801 and 802 or, alternatively, from a separate device (not shown). The user can then select which programs are to be transmitted to the internet appliances 801 and 802 and/or modify account information. Preferably, each user account has its own user list of associated preferences and the server store multiple accounts corresponding to multiple user locations.

In an alternative embodiment of the instant invention, program schedules are assigned to internet appliances 801 and 802 according to the programs schedule assigned to the devices. Accordingly, a user sets up a list of preferences for each internet appliance 801 and 802 and program transmissions which are receivable at each of the internet appliances 801 and 802, as determined by program schedule generated for each internet appliance 801 or 802. Preferably, the servers 807 and 811 are responsible for controlling the authorization of the appliances 801 and 802 to receive a program transmission from the providers 812 and 815

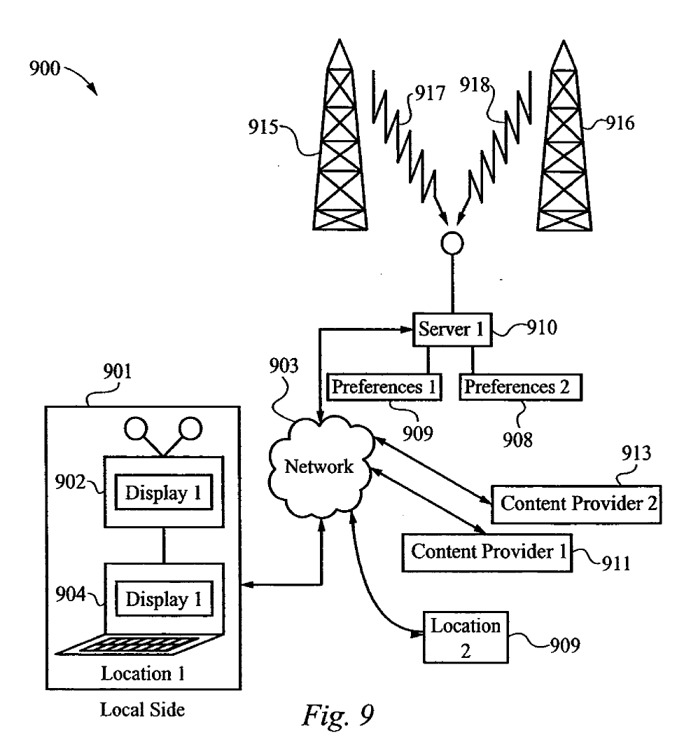

FIG. 9 shows an alternative architecture 900 for distributing content data, in accordance with the instant invention. In the architecture 900, a server 910 receives broadcast content data 917 and 918 from broadcast content providers 915 and 916, respectively. In this way, the sever 910 is an “intermediate content provider” for provisioning content data transmissions 917 and 918 indirectly to a receiving device 901. The distribution of broadcast content data is preferably determined by a program schedule stored on the server 910 which is based on a corresponding list of user or device preferences, as described in detail above.

Still referring to FIG. 9, content providers 911 and 913 are coupled to the network 903 for transmitting programs, to the receiving device 901. The programs are preferably digital video programs. The receiving device 901 preferably comprises a computer 904 and a television 902. Users can access their schedules via the network 903 and modify the preferences 908 and 909 including their choice of which providers 911 and 913 and select programs to be received from each of the providers 911 and 913.

The architecture 900 can provide for the ability to select a second receiving location 909 to receive a program transmission. The second receiving location 909 is preferably coupled to the network 903 and/or is configured to selectively receive broadcast content data from at least one of the providers 915 and 916 and/or control from the providers 911 and 913. When program transmissions are digital video program transmissions, the second location is preferably identified by providing the server 910 with a logical address corresponding to the second receiving location 909.

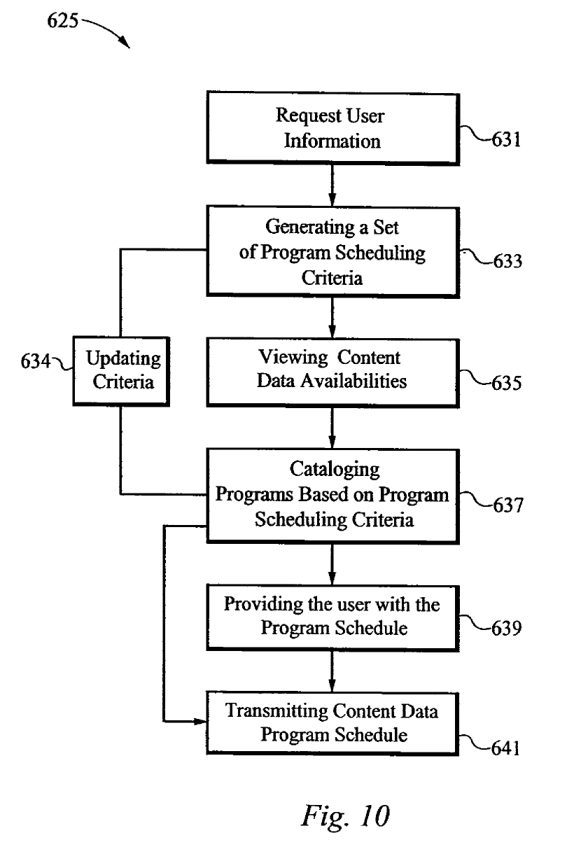

FIG. 10 is a schematic block diagram 625 outlining steps for distributing content data, in accordance with a method of the instant invention. When the user first sets up an account at a the system server in the step 631, there is preferably a request for user information. The request for user information can be made by telephone, e-mail, ground mail, surveys or any other suitable means including unsolicited means. Preferably, users can visit a web site and set up their own account. User information can include, but is not limited to provider selections and service selections. Additionally, user information preferably includes a list of preferences. User preferences can include information such as the type of programs in which the user is interested, the user likes and dislikes and/or preferred times to receive program transmissions. The user preferences can also specify a user location to receive program transmissions. After the account is established, the system preferably provides the user with an estimate of the cost and a list of the subscribed services and a personal identification number.

In the step 633, a program scheduling criteria is developed. The program scheduling criteria can be any simple or complex algorithm, but preferably includes weighting factors for user preferences acquired in the step 631. For example, in the step 631 a user inputs that their professional interests include healthcare. Thus, programs which deal with healthcare issues may be given high priority in the customized program schedule developed in the step 639. If in the step 631 the user inputs that they do not like sports, then sports programs can selectively be eliminated from the customized program schedule or, alternatively, are give low priority in the customized program schedule developed for that user in the step 639.

After the program scheduling criteria is generated in the step 633, then in step the 635, the server reviews program availabilities for all of the designated content providers. The server can obtain program availabilities automatically from the content provider or, alternatively, extract program availabilities over the network. In yet a further embodiments, the program availabilities can be entered into the server manually. Program availabilities are preferably updated at the server as new programs become available or as program availabilities change. After the program availabilities are compiled at the server in the step 637, the server catalogs the programs into a customized program schedule according to the user criteria and preferably organized into a display format, such as illustrated in FIGS. 1-3. Customized program schedules are preferably viewable over the system network, wherein the user program schedule is displayed on a display device with a graphical user interface. To ensure privacy, the system can be set up with a password to secure user preferences and programming schedules.

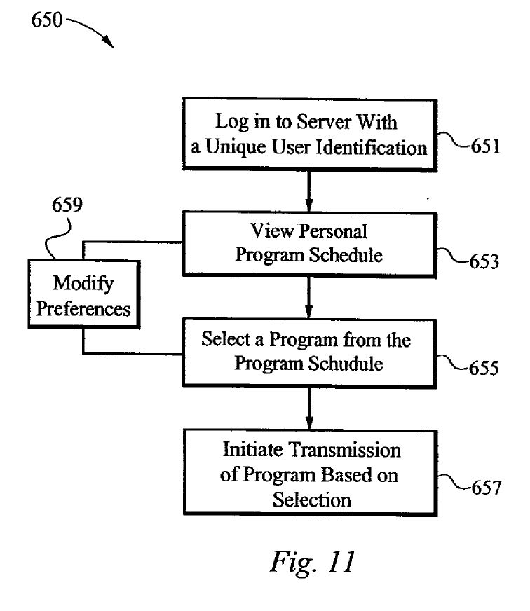

FIG. 11 shows a flowchart 650 outlining the step for selecting a program in accordance with the preferred method of the instant invention. In the step 651, a user preferably can log into their personal account by providing a secured user code, such as a user identification number. Then in step 653, the user can view their personal program schedule. In the step 655, the user can select programs from their schedule. Preferably, the program schedule is supported by a graphical user interface which allows the user to point-and-click on a displayed program icon to select a program. After the program is selected in the step 655, then in the step 657 transmission of the program content data to user location is initiated.

After viewing the personal program schedule in the step 653, the user can preferably modify the account and/or user preferences. By refreshing the account, the server re-compiles program availabilities based on the new account information or modified preferences. It is also preferable that the user can search a server data based for alternative programs, which are not displayed in the personal program schedule, using a simple search engine.

After the program is selected in the step 655, then in the step 657 the transmission of the program to the user location is initiated by any number of conventional mechanisms including, but not limited to, initiating a broadcast of a program, decoding a local receiver to receive an encrypted broadcast, transmitting data to a port on a system network or be routed from the server to a receiving device or alternatively can be distributed directed from the content provide which receives authorization for the server to transmit programs to the user location. In accordance with a preferred embodiment of the invention, the system for distributing content data is a pay-per-view system, wherein the user is automatically billed for each program transmission.

The customized program schedules utilized in the instant invention can be supported with any number of network architectures, hardware and software. Therefore, the present invention has been described in terms of specific embodiments incorporating details to facilitate the understanding of the principles of construction and operation of the invention. Such reference herein to specific embodiments and details thereof is not intended to limit the scope of the claims appended hereto. It will be apparent to those skilled in the art that modifications can be made in the embodiment chosen for illustration without departing from the spirit and scope of the invention.

What is claimed is:

1. An electronic program schedule comprising:
a source field for listing content providers;
a content field for listing a first set of variable program time corresponding to times when content data is available from the content providers; and
an appliance field for providing a listing of at least one network enabled home appliance.

2. The electronic program schedule of claim 1, wherein the content field is configured for listing program titles available from the content providers corresponding to a first set of entries with program times.

3. The electronic program schedule of claim 2, wherein the source field and the content field are displayable in parallel columns with each one of the content providers aligned with a corresponding program title and a corresponding program time.

4. The electronic program schedule of claim 1, further comprising a second set of entries in the content field.

5. The electronic program schedule of claim 4, wherein the second set of entries list program times corresponding to times when a second set of content data is available from the content providers.

6. The electronic program schedule of claim 5, wherein the second set of entries further list program titles corresponding to the second set of content data.

7. The electronic program schedule of claim 1, further comprising a descriptor field for displaying a detailed description of a portion of the content data available from one or more of the content providers.

8. The electronic program schedule of claim 7, wherein the portion of the content data is selected by a user.

9. The electronic program schedule of claim 1, further comprising a filter field with at least one filter selection, wherein each filter selection is configured to select content providers listed in the source field.

10. The electronic program schedule of claim 2, further comprising a filter field with at least one filter selection, wherein each filter selection is configured to select the program titles listed in the source data field.

11. The electronic program schedule of claim 1, further comprising a search field for searching content data available from the content providers.

12. The electronic program schedule of claim 1, wherein the appliance field is configured for listing a status of each network enabled home appliance.

13. The electronic program schedule of claim 1, further comprising a control field for selectively operating each network enabled home appliance.

14. A schedule for simultaneously displaying program availabilities from scheduled content providers and on-demand content providers, the schedule comprising:
a source field for listing the scheduled content providers and for listing the on-demand providers; and
a content field for listing the program availabilities, wherein the content field is further configured for listing at least one network enabled home appliance and a status corresponding to the appliance.

15. The schedule of claim 14, wherein the source field is configured for listing the content providers in a first column and corresponding program availabilities in an adjacent and second column.

16. The schedule of claim 15, wherein the content field further comprises a third column for listing additional program availabilities.

17. The schedule of claim 14, wherein the content field is configured for listing variable program times from the scheduled program providers.

18. The schedule of claim 14, wherein the content field is configured to provide a description of a selected program availability.

19. The schedule of claim 14, wherein the program availability are selectable with a control device.

20. The schedule of claim 14, further comprising a filter field with one or more filter sections for filtering content provider listed in the source field.

21. The schedule of claim 14, further comprising a filter field with one or more filter selections for filtering program availabilities listed in the content field.

22. The schedule of claim 14, further comprising a search field for searching program availabilities from the content providers.

23. The schedule of claim 22, wherein the search field is configured for searching program availabilities from a selected content provider.

24. The schedule of claim 14, further comprising control field for selectively controlling the one or more network enabled home appliances.

25. The schedule of claim 1, wherein said at least one appliance is a kitchen refrigerator.

26. The schedule of claim 14, wherein said at least one appliance is a kitchen refrigerator.
